(19) United States
(12) Patent Application Publication
(10) Pub. No.: US 2019/0170184 A1
(43) Pub. Date: Jun. 6, 2019

(54) CONNECTION TYPE BETWEEN A POWER SOURCE AND A PROGRESSING CAVITY PUMP FOR SUBMERSIBLE APPLICATION

(71) Applicant: AILIFT (TIANJIN) SCIENCE CO., LTD., Tianjin City (CN)

(72) Inventors: David Lester Olson, Los Alamitos, CA (US); Xiaoyan Yan, Tianjin City (CN); Darin Austin, Tulsa, OK (US); Bin Wang, Tianjin City (CN)

(73) Assignee: AILIFT (TIANJIN) SCIENCE CO.; LTD., Tianjin City (CN)

(21) Appl. No.: 15/992,394

(22) Filed: May 30, 2018

(30) Foreign Application Priority Data
Dec. 4, 2017 (CN) 201721665245.1

(51) Int. Cl. F16C 3/02; F04D 29/044; F04D 13/08; F16D 1/06; F16D 3/06

(52) U.S. Cl. CPC F16C 3/02; F04D 29/044; F04D 25/06; F16D 1/06; F16D 3/06; F04D 13/08

(57) ABSTRACT

A torque shaft, and couplings for connecting a progressing cavity pump and a driving part. The torque shaft, which accommodates the differing rotational motion of driver shaft and pump rotor, includes a shaft body and shaft heads both ends of the shaft body. The shaft heads have a transverse cross section of a hexagonal shape. An assembly for connecting a pump with a driving part which includes the above-mentioned torque shaft, a driver coupling, and a pump coupling and static components that connect the driving part housing to the progressing cavity pump stator. The connecting assembly includes provision for containing up thrust when the pump rotor rotation is reversed.

### BACKGROUND OF THE INVENTION

### 1. Technical Field

The present invention relates to submersible apparatuses, and in particular a shaft and shaft assembly connecting a progressing cavity pump and a driving part.

### 2. Background Art

A progressing cavity pump is a volumetric rotor pump that absorbs and discharges liquid through the volumetric change of a series of sealed chambers. The simplest design of the progressing cavity pump consists of a single external helix that revolves eccentrically within an internal double helix. The internal helix has the same minor diameter and twice the pitch length of the external helix. The eccentricity is the locus of the rotor axis as its geometry rotates against the geometry of the stator. For oil field applications, the rotor is metal and the stator an elastomer that is injection molded within tubing. The rotor and stator are assembled with a compression fit. When the stator and rotor are assembled a series of cavities are formed. The cavities are sealed by the fit comprised of two lines on the rotor 180° apart. As the rotor turns the cavities spiral (progress) along the pump axis so that as one cavity diminishes, the following cavity increases. The fluid cross section is unchanged throughout the length of the stator, regardless of rotor position, resulting in a pulsation-free, positive axial flow.

A progressing cavity pump can also consist of a multiple helix rotor and corresponding stator—a multi-lobe pump. These are the preferred elements for drilling mud motors. Multiple helix designs can have any number of helices as long as there is one more helix in the stator than on its mating rotor. For pumps, the most affordable and practical multi-lobe pump design is a double helix rotor with a triple helix stator.

There is no inherent directionality in the progressing cavity pump elements. There is no top or bottom until other equipment is attached. Though the helices of a pump are conventionally right hand, there is nothing between pump elements that dictate the direction of rotation. If a stator is constrained horizontally on a bench, the pump maybe assembled by inserting the rotor in one end then rotating it clockwise into the stator. The rotor is backed out with counterclockwise rotation. In operation, both rotor and stator are held against axial movement. If the rotor is rotated clockwise, the fluid moves toward the viewer and the thrust away. If counterclockwise, the fluid moves away from the viewer and the thrust opposite. Some of the power driving a progressing cavity pump is converted to thrust since the liquid moves along the same axis as the rotating parts.

A shaft connection between a motor, which shaft revolves concentrically, and an above described progressing cavity pump must, necessarily, accommodate eccentric revolution on one end to match the motion of the pump rotor. Such connection is most reliably accomplished with a torque shaft.

The shaft connections for progressing cavity pumps that are currently available in the market have the following disadvantages:

Splines of conventional design, which are commonly employed at both ends of the shaft of the pump in the prior art, are easily susceptible to stress fatigue in spline connection when the pump operates continuously, resulting in problems such as a damage or fracturing of the spline.

Conventional splines require expensive machining processes for both shaft and mating parts.

Damaged conventional splines are difficult to repair, especially in the field.

Often, in conventional spline shafts, the spline is cut directly on a bar of one continuous diameter so that the outside diameter of the spline is the same as the diameter of the body of the shaft. Thus, the transverse cross section of the shaft is reduced at the spline, decreasing the maximum possible torque transmission.

In practical use, the pump rotation needs to be reversed for some reason. For example, the pump may be reversed for cleanup when the sand is produced in the oil wells. The pump rotor will move upwards when operated in reverse rotation. Thus, in the prior art, a thrust plate is additionally placed on the top of the pump for preventing the pump rotor from being detached from the connector. The thrust plate is usually fixed by welding, and it requires a precise shop measurement to correctly position the thrust plate. This practice to some extent increases the workload.

There remains a need for a shaft design that can address the technical problems in the prior art, such as a short service life due to stress fatigue readily caused by the torque shaft.

### SUMMARY OF THE INVENTION

The present invention provides for a torque shaft, including a shaft body, wherein the torque shaft includes shaft heads and a shaft body, the shaft heads are provided on both ends of the shaft body, respectively, and the shaft heads are configured to fix the shaft body to a driving and driven member, and each of the shaft heads has a transverse cross section of a hexagonal shape.

The present invention also provides for a connector for connecting a progressing cavity pump and a driving part, wherein the connector includes the torque shaft above, and further includes a driver coupling and a pump coupling, wherein the couplings are provided with a hexagonal cavity compatible with the shaft heads, the driver coupling is installed on and fixed to one shaft head, and the pump coupling is installed on and fixed to the other shaft head, one end of the driving coupling has a mating feature appropriate for attachment to the driving part shaft, one end of the pump coupling has a mating feature appropriate for attachment to the pump rotor, and each of the couplings is fixed to the shaft head by two fasteners passing through its outside diameter into either side of the shaft head aperture, fixing the coupling to the shaft head from axial motion.

### DESCRIPTION OF THE DRAWINGS

Other advantages of the present invention are readily appreciated as the same becomes better understood by reference to the following detailed description when considered in connection with the accompanying drawings wherein:

FIG. 1 is a schematic diagram of the torque shaft provided according to the First Embodiment;

FIG. 2 is a side view of the torque shaft provided according to the First Embodiment;

FIG. 3 is a schematic diagram of a connector for connecting a pump and a driving part, as provided according to the Second Embodiment; and

FIG. 4 is a partial enlarged view of the connector for connecting the pump and the driving part, and of the driving part connection end, as provided according to the Second Embodiment.

The present invention generally provides for a torque shaft, as well as couplings for connecting a progressing cavity pump and a driving part.

The torque shaft includes shaft heads 20 and a shaft body 10, where the shaft heads 20 are provided on both ends of the shaft body 10 and the shaft heads 20 are configured to fix the shaft body 10 to a driving and driven member.

The shaft heads 20 have a transverse cross section of hexagonal shape.

Further, a transition part is provided between the shaft head 20 and the shaft body 10.

A second object of the present invention is to provide a connector for connecting a progressing cavity pump and a driving part, so as to address the technical problems in the prior art.

The connector is composed of internal, rotating components, such as a torque shaft 100, and external, stationary components, such as a casing 170.

Provided is a connector for connecting a pump and a driving part, where the connector includes the above-mentioned torque shaft 100 and further includes a driver coupling 110 and a pump coupling 120. The torque shaft heads are inserted into corresponding hexagonal cavities in the driver coupling 110 and the pump coupling 120.

Further, a fastener is also included for each coupling. The fastener passes through the outside diameter of each coupling into an aperture in each shaft head, so as to fix the shaft heads to the couplings.

The driver coupling 110 possesses a suitable mating feature for the driving part on one end. The pump coupling 120 possesses a suitable mating feature for the pump rotor on one end. A thrust nut 140 is attached to the driver coupling 110.

Further, a connector base 150, a thrust nipple 190, a connector casing 170, and a pump stator adaption 160 are included.

The base 150 is fixedly connected to the driver part housing, the thrust nipple 190 is fixedly connected to the connector base 150, the connector casing 170 is fixedly connected to the thrust nipple 190, the pump stator adaption 160 is fixedly connected to the connector casing 170, and the pump stator is fixedly connected to the pump stator adaption 160.

The connector base 150 has an internal diameter nominally the same size as a corresponding diameter of the driver coupling 110. The diameter serves as a bearing surface for the coupling 110 so that the driver coupling 110 rotates concentrically with the driver part shaft.

The thrust nipple 190 has an internal surface perpendicular to the axis of the driver coupling 110. This surface serves as an up thrust bearing when the coupling 110 is moved upward by reverse rotation of the pump rotor, engaging the thrust nut 140 attached to the driver coupling 110. The thrust nut 140 does not contact the thrust surface of the thrust nipple 190 when the pump is operating normally, the pump rotor is thrust is directed away from the thrust surface.

The connector casing 170 is provided outside the shaft body 10. The casing 170 is perforated to allow entry of well fluid to the suction end of the progressing cavity pump.

The present invention has the following beneficial effects:

The present invention provides a torque shaft including a shaft body 10; the shaft body 10 includes a shaft head 20 and a shaft body 10; and a shaft head 20 is provided on both ends of the shaft body 10. The shaft head 20 has a transverse cross section of hexagonal shape, namely, the shaft head 20 is provided as a hexagonal shaft head. The outer sidewall of the shaft segment of the shaft head 20 has six corners, and a planar structure with a certain width is provided between adjacent corners. This increases the contact area when the shaft head 20 is connected, and addresses the defects in splined connection, as employed in the traditional technology, which is susceptible to stress fatigue when the torque is transmitted due to multiple-corner structure of the spline. Corners, both at diametral changes in cross section in the transverse plane, increase the concentration of torque stress leading to increased probability of damage or fracture at the spline. Further, the hexagonal cross section provides increased cross section area when compared to a conventional spline of similar size, leading to increased torque capacity.

The present invention also provides a connector for connecting a pump and a driving part, which includes the above-mentioned torque shaft 100, a driver coupling 110, with thrust nut 140, and a pump coupling 120 and further includes a connector base 150, thrust nipple 190, connector casing 170, and pump stator adaption 160. Prior art includes a thrust plate welded on top of the progressing cavity pump stator, which location is carefully established by shop measurements. The thrust plate is made necessary since a progressing cavity pump rotor will move upward when the rotation is reversed, thus disengaging elements of the shafting string between the driving part and the pump. In the present invention, welding and measurement to establish location are eliminated. Further, the thrust surface provided in this disclosure is larger than is possible at the top of a pump stator, and thus is more reliable.

The technical solutions of the present invention will be described clearly and comprehensively by referring to the figures below. It is apparent that the embodiments to be described are part, but not all, of the embodiments of the present disclosure. All of the other embodiments obtained by those skilled in the art from the embodiments of the present invention without making an inventive effort will fall within the scope of the present invention as claimed.

It should be noted that, in the description of the present invention, unless otherwise expressly specified or defined, terms of “mount”, “couple”, and “connect” should be understood in broad sense. For example, a connection could be a fixed connection, a detachable connection, or an integrated connection; it could be a mechanical connection or an electric connection; or it could be a direct connection, or an indirect connection via an intermediate medium, or it could be an internal communication between two elements. The specific meanings of the above-mentioned terms in the present invention could be understood by those skilled in the art according to specific situations.

Transverse is to be understood as perpendicular to the nominal axis of the shaft.

### FIRST EMBODIMENT

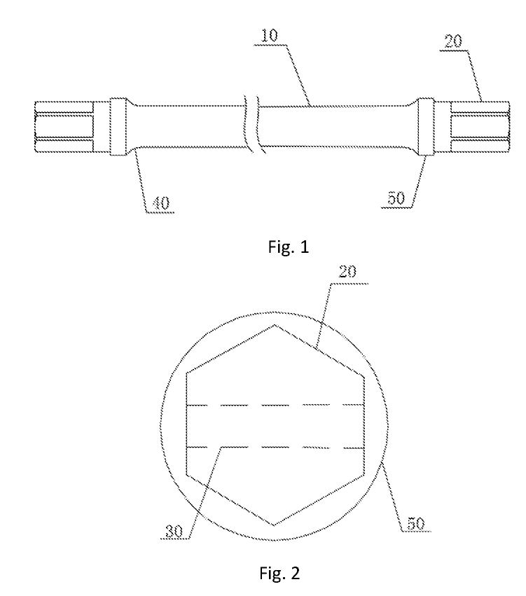

As shown in FIGS. 1-2, the torque shaft provided in this embodiment includes a shaft body 10; a shaft head 20 is provided on both ends of the shaft body 10. The shaft head 20 is configured to fix the shaft body to a driving member. The transverse cross section of the shaft head 20 has a hexagonal shape.

Specifically, the torque shaft is comprised of a shaft body 10 transitioning on both ends to a shaft head 20. The shaft head 20 is a shaft segment configured for fitting with a rotational component. Therefore, through the shaft head 20, the shaft body can be fixedly connected to the driving and driven member, for transmitting rotational motion and torque. The shaft body 10 is a non-fitting shaft segment connected to the shaft head 20.

Here, the shaft head 20 has a transverse cross section of hexagonal structure. Namely, the shaft head 20 is provided as a hexagonal shaft head 20. The outer sidewall of its shaft segment has six corners, and there is a planar structure with a certain width between the adjacent corners. This increases the contact area when the shaft head 20 is connected, and also distributes evenly the stress generated from connection. By fixing the shaft body 10 having a hexagonal shaft head 20 to the rest of the driving members, it addresses the problems associated with splined connection in the traditional technology, that is, due to multiple small radii inherent in splines of any type, which are stress concentrators, the spline is susceptible to stress fatigue when the torque is transmitted, which leads to a damage or fracture of the spline.

In the optional aspects of this embodiment, as shown in FIGS. 1-2, the shaft head 20 is provided thereon with a fixing aperture 30. The fixing aperture 30 passes through the shaft head 20 perpendicular to the axis of the shaft head 20.

Specifically, the fixing aperture 30 is provided on the shaft head 20 close to the end face, and the fixing aperture 30 is configured to pass through the shaft head 20 perpendicular to the axis of the shaft head 20. The torque shaft can be fixedly connected to other components by a connecting member such as a screw passing through or into the fixing aperture 30.

Here, a fixed connection is achieved by a locking screw passing through the fixing aperture 30.

Specifically, one end of the torque shaft is coupled to the progressing cavity pump rotor and the other end is coupled to the driving part, so the torque shaft is mainly configured to transmit motion and torque. The torque shaft includes a shaft body 10 and shaft heads 20 at both ends. The shaft head 20 is configured to connect to the pump rotor and to the driving part, and the shaft body 10 acts as a joining part; when the shaft head 20 is coupled to the pump rotor and to the driving part, in order to prevent the connection from separating, the shaft head 20 needs to be fixed to the coupling thereto. Thus, a screw or other fastener is inserted through the coupling into the aperture 30.

In the optional aspect of this embodiment, as shown in FIGS. 1-2, a transition area is provided between the shaft heads 20 and the shaft body 10.

In an optional aspect of this embodiment, as shown in FIGS. 1-2, the transition part includes a circular arc transition area 40 and a cylindrical transition area 50.

Specifically, the transition part is provided between the shaft body 10 and the shaft head 20. The transition part includes a cylindrical transition area 50 and a circular arc transition area 40. The circular arc transition area 40 is provided at a position where the shaft body 10 is between part and the cylindrical transition area 50 is provided between the circular arc transition area 40 and shaft head 20.

Here, the circular arc transition area 40 is configured to reduce the stress concentration at the shaft body 10 of the torque shaft due to an abrupt change in the cross section between the shaft body 10 and the head 20 which will otherwise reduce the service life of the torque shaft. The cylindrical transition area 50 is configured to provide a standoff surface to protect the shaft head 10 during handling and storage.

Here, the torque shaft, consisting of the main body 50, the circular arc transition area 40, the cylindrical transition area 40, and the shaft head 10, is made from a single blank sucker rod forging.

Specifically, since sucker rods are used to drive progressing cavity pumps in some applications, transmit similar torque, transmit similar motion, are exposed to well fluid, and have similar geometry, the sucker rod forging is an especially suitable selection for torque shaft material. Such a forging is made so that the main body 10 is already formed and it transitions through an already formed circular arc 40 to upset ends with a diameter larger than the main body 10 and larger than the cylindrical transition area and shaft head. The upset ends are machined to form the cylindrical transition area and shaft head.

Here, the forged transition to a larger diameter is an improvement over current practice of turning bar down to the diameter of the main body in that the forging forms the grain of the material to follow the contour of the ultimate torque shaft surface in contrast to cutting across the material grain when making shaft in current practice. The continuous grains provide a more fatigue resistant torque shaft.

### SECOND EMBODIMENT

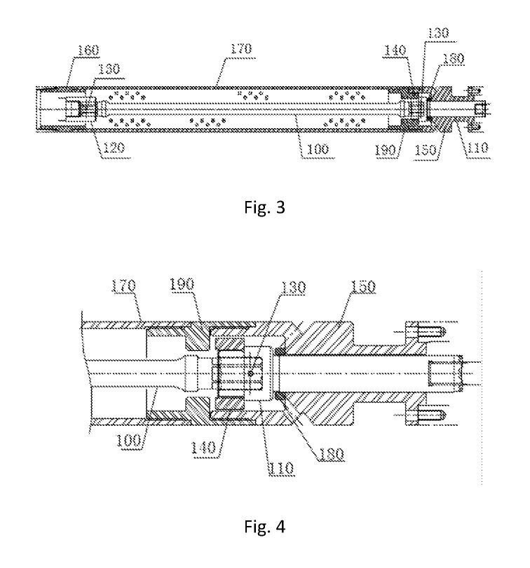

The present invention also provides a connector for connecting a progressing cavity pump and a driving part. As shown in FIGS. 3-4, the connector for connecting the progressing cavity pump and the driving part as provided according to this embodiment has rotating components which include the above-mentioned torque shaft 100, and also include a driver coupling 110, a thrust nut 140, and a pump coupling 120. Further, this embodiment has static components which include a connector base 150, a thrust nipple 190, a connector casing, and a pump stator adaption 160.

Here, the one end of the driving coupling 110 is configured to connect a driving part, for example, to connect a protector in the driving part, and one end of the driven coupling 120 is configured to connect a progressing cavity pump.

Specifically, the driver and driving couplings each have a hexagonal cavity on one end corresponding to the transverse hexagonal cross section of the shaft head 20. The driver coupling 110 is internally splined on one end corresponding to the conventionally provided external spline of the driving part. The driven coupling 120 is internally threaded on one end corresponding to the conventionally provided sucker rod thread on the pump rotor. The driven coupling is installed onto the pump rotor, applying the torque appropriate for the pump rotor thread size, thus fixing the driven coupling to the pump rotor. One torque shaft head 20 is inserted into the driving coupling 110 cavity and fixed by inserting locking screws 130 through the coupling into the aperture 30, similarly, the other torque shaft head 20 is inserted into the driven coupling 120 cavity and fixed using locking screws 130. Thus, the driving coupling 110, torque shaft 100, the driven coupling, and the pump rotor are fixed torsionally and axially so will move as one assembly.

A thrust nut 140 is installed onto the driving coupling 110, and it rotates and travels axially as one with the driving coupling 110.

Specifically, the nut 140 is threaded onto the outside diameter of the driven coupling 110 and located firmly at one end against a shoulder. The nut 140 able to bear an axial force imposed in an upward direction. During normal operation of the progressing cavity pump, the thrust nut 140 is spaced so that there is no contact with any portion of the static components of the connector.

By fixedly connecting the pump rotor, the driving coupling 110, with thrust nut 140, the torque shaft 100, and the driven coupling 120, the thrust nut 140 will engage the thrust nipple 190 when the pump rotor is revolving in reverse. Thus, the rotor will remain in place. Moreover, in the prior art, in order to prevent the progressing cavity pump from moving upwards when run in reverse, a thrust plate is welded on the top of the progressing cavity pump. Since the thrust plate is welded onto the progressing cavity pump, it is not easy to replace the thrust plate after being damaged. Furthermore, careful shop measurements are necessary to correctly position the thrust plate. To some extent, the assembly time is increased. In the present embodiment, however, the extensive measurement and welding are avoided.

In an additional aspect of this embodiment, as shown in FIGS. 3-4, a spacer 180 is further included. The spacer 180 is provided on the driving coupling 110 between the connector base 150 and the driver coupling 110. The spacer 180 is configured to limit downward movement of the driving coupling 110 during handling. Once the connector is installed with the driving part, the spacer 180 serves no further purpose.

In an optional aspect of this embodiment, as shown in FIGS. 3-4, this embodiment has static components which include a connector base 150, a thrust nipple 190, a connector casing, and a pump stator adaption 160.

Specifically, the connector base 150 attaches to the housing of the driving part and threads into the thrust nipple 190. Additionally, internally, the connector base 150 has a cylindrical bearing surface which is sized for the outside diameter of the lower part of the driving coupling 110. The driving coupling 110 revolves within and against the connector base 150, thus the revolution of the driving coupling 110 is concentric with the axis of the driving part assuring that one end of the torque shaft 100 is revolving concentrically and isolating the driving part from the orbiting eccentricity of the pump rotor. The thrust nipple 190 threads onto the base 150 and threads into the connector casing 170. Additionally, internally, the thrust nipple 190 has a transverse bearing surface which serves to engage the thrust nut 140 should the pump rotor travel upward on reverse rotation of the pump. The connector casing 170 threads onto the thrust nipple 150 and threads onto the pump stator adaption 160. Additionally, the connector casing is perforated with multiple small holes to allow the passage of well fluid, thus the connector casing 170 serves as the progressing cavity pump intake. The pump stator adaption 160 threads into the connector casing 170 and threads into the pump stator. The pump stator adaption 160 adapts the connector casing to the various progressing cavity pump stator thread sizes and types.

Finally, it should be noted that the above embodiments are merely intended to explain the technical solutions of the application and are not intended to limit the application. Although the present invention has been illustrated in detail with reference to the foregoing embodiments, it would be understood by persons of ordinary skill in the art that the technical solutions described in the foregoing embodiments can still be modified, or that part or all of the technical features thereof can be replaced by equivalent substitution. These modifications or substitutions do not cause the principle of the corresponding technical solutions to depart from the scope of the technical solutions of the embodiments of the application.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A torque shaft, comprising a shaft body,
wherein the torque shaft comprises shaft heads and a shaft body, the shaft heads are provided on both ends of the shaft body, respectively, and the shaft heads are configured to fix the shaft body to a driving and driven member; and
each of the shaft heads has a transverse cross section of a hexagonal shape.

2. The torque shaft according to claim 1, wherein a fixing aperture is provided on each of the shaft heads, and the fixing aperture runs through the shaft head perpendicular to the axis of the shaft head.

3. The torque shaft according to claim 1, wherein a transition part is provided between each of the shaft heads and the shaft body.

4. The torque shaft according to claim 3, wherein the transition part comprises a circular arc transition area and a cylindrical transition area, and the circular arc transition area is provided at either end of the shaft body.

5. A connector for connecting a progressing cavity pump and a driving part, wherein the connector comprises the torque shaft of claim 1, and further comprises a driver coupling and a pump coupling,
wherein the couplings are provided with a hexagonal cavity compatible with the shaft heads, the driver coupling is installed on and fixed to one shaft head, and the pump coupling is installed on and fixed to the other shaft head,
one end of the driving coupling has a mating feature appropriate for attachment to the driving part shaft,
one end of the pump coupling has a mating feature appropriate for attachment to the pump rotor, and
each of the couplings is fixed to the shaft head by two fasteners passing through its outside diameter into either side of the shaft head aperture, fixing the coupling to the shaft head from axial motion.

6. The connector for connecting a progressing cavity pump and a driving part according to claim 5, wherein the connector further comprises a connecting base, a thrust nipple, a connector casing, and a pump stator adaption,
wherein the driver part housing is fixedly connected to the connector base, the thrust nipple is fixedly connected to the connector base, the connector casing is fixedly connected to the thrust nipple, the pump stator adaption is fixedly connected to the connector casing, and the progressing cavity pump stator is fixedly connected to the pump stator adaption,
the connector casing is perforated to allow passage of well fluid,
the connector base has an internal cylindrical bearing surface, nominally sized as the lower outside diameter of the driver coupling, which serves to constrain the driver coupling rotation concentric to that of the driver, and
the thrust nipple has an internal surface perpendicular to its central axis at its upper end which serves as an upward thrust bearing surface.

7. The connector for connecting a progressing cavity pump and a driving part according to claim 6, wherein the connector further comprises a thrust nut, the thrust nut is fixedly attached to the driving coupling, and during normal operation of the progressing cavity pump, the rotor thrust direction is away from the thrust surface of the thrust nipple so that the thrust nut is not in contact with the thrust nipple.

8. The connector for connecting a progressing cavity pump and a driving part according to claim 7, wherein a spacer is provided on the driving coupling, located between the driving coupling and the connecting base.
